(19) United States
(12) Patent Application Publication
(10) Pub. No.: US 2006/0222318 A1
(43) Pub. Date: Oct. 5, 2006

(54) Information processing apparatus and its method

(75) Inventors: Kohei Momosaki, Kanagawa (JP); Tatsuya Uehara, Tokyo (JP); Manabu Nagao, Tokyo (JP); Yasuyuki Masai, Kanagawa (JP); Kazuhiko Abe, Kanagawa (JP); Kazunori Imoto, Kanagawa (JP); Munehiko Sasajima, Osaka (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/391,365

(22) Filed: Mar. 29, 2006

(30) Foreign Application Priority Data
Mar. 30, 2005 (JP) 2005-100192
Feb. 27, 2006 (JP) 2006-051226

(51) Int. Cl. H04N 5/91

(52) U.S. Cl. 386/46

(57) ABSTRACT

There is provided an information processing apparatus in which with respect to video to be recorded and stored, division suitable for viewing, the determination of control points and the giving of relevant information can be performed without requiring a manual operation each time. A video/audio processing apparatus includes a key data management part 10, a video data acquisition part 41, an audio data separation part 22, a key matching part 30, a matching result recording instruction part 35, and a recording medium 90, detects an audio period similar to an audio pattern of a key from audio data, determines division points or control points in accordance with a previously specified attribute and with reference to a starting and a terminal ends of the detected period, and sets a previously specified name or a name given in accordance with a previously specified naming method to a divided period, the control point or the whole audio data.

### CROSS-REFERENCE TO RELATED APPLICATIONS

This application is based upon and claims the benefit of priority from the prior Japanese Patent Application No. 2005-100192, filed on Mar. 30, 2005 and No. 2006-51226, filed on Feb. 27, 2006; the entire contents of which are incorporated herein by reference.

### TECHNICAL FIELD

The present invention relates to an information processing apparatus for performing a processing of video/audio or audio recording, and its method.

### BACKGROUND OF THE INVENTION

In recent years, the dominating equipment for recording audio and video is shifted from a conventional analog magnetic tape to a digital magnetic disk, semiconductor memory or the like. Especially in a video recording and reproducing equipment using a large capacity hard disk, the recordable capacity is remarkably increased. When such an equipment is used, videos of many programs provided by broadcast or communication are stored, and the user can freely select and view them.

Here, in the management of the stored videos, files are formed using titles (programs) as units of programs or the like, and names and other information are given, and when they are listed, typical images (thumbnails) of the titles, the names and the like are arranged and can be displayed. Besides, one program (title) is divided into units called chapters (segments), and reproduction and editing can also be performed in chapter units. When chapter names are given, and typical images (thumbnails) of chapters are displayed, a chapter including a favorite scene can be selected and reproduced from a chapter list, or selected chapters can be arranged to create a play list or the like. As regulations on management methods of these, there is a VR (VideoRecording) mode of DVD (Digital Versatile Disc).

Incidentally, a marker used for specification of a period or a position in a program (title) includes reproduction time information corresponding to a time position at a time when video and audio content is reproduced, and in addition to a chapter marker expressing a chapter division point, according to a device, there is also a case where an edit marker to specify an object period at an editing operation, or an index marker to specify a point of jump destination at a cue operation is used. Incidentally, the “marker” in the present specification is also used in the above meaning.

With respect to a program name, when program information provided by EPG (Electronic Program Guide) or the like is used, it can be automatically given to a recorded and stored file. With respect to the program information provided by the EPG, there is ARIB (Association of Radio Industries and Businesses) standard (STD-B10).

However, with respect to the inside of one program, although various data, such as information to give a division time position and a name to enable easy identification of each of divided parts, are conceivable as metadata useful in supporting viewing, editing and the like and in performing automation, these are hardly general-purposely provided from the outside. Thus, in an equipment for a general viewer, it is necessary for an apparatus side to create metadata based on the recorded audio and video.

As a general-purpose description format of metadata relating to video and audio content, there is MPEG-7, and there is a method in which metadata is made to correspond to content and is stored in XML (extensible Markup Language) database. Besides, with respect to a transmission system of metadata in broadcasting, there is ARIB (Association of Radio Industries and Businesses) standard (STD-B38), and the metadata can also be recorded in accordance with these.

As what is automatically performed by an apparatus, there is also a case in which a chapter division function by detection of a silent portion, switching (cut) of video, switching of audio-multiplex mode (mono, stereo, dual mono for bilingual) or the like is provided (see, for example, patent document 1 (JP-A-2003-36653)). However, the division is not necessarily suitably performed, and the user must manually perform considerable work including the giving of a significance to each of the divided chapters and the giving of a name.

Besides, with respect to metadata creation of automatic keyword extraction or the like using language information obtained by telop image recognition or speech recognition, the use in full-text retrieval has become possible (see, for example, patent document 2 (JP-A-8-249343)). However, with respect to the portions such as the chapter division and the giving of a name, the whole application is difficult under the present circumstances.

On the other hand, although methods of acoustic retrieval or audio robust matching to retrieve the coincidence or similarity of sounds have been conceived, most of them are used in such a form that a music or the like whose viewing and listening is desired is retrieved and reproduced, and the structure is not suitable for metadata creation of video, or the like (see, for example, patent document 3 (JP-A-2000-312343)).

As stated above, in the related art, in the management of a large amount of stored video, especially in the division of one program, there has been a problem that it is impossible to easily perform the division suitable for viewing and listening, the determination of control points and the giving of relevant information.

Then, the present invention has been made in view of the above circumstances, and has an object to provide an information processing apparatus and its method, in which with respect to video to be recorded and stored, division suitable for viewing and listening, the determination of control points, and the giving of relevant information can be performed without requiring a manual operation each time.

### BRIEF SUMMARY OF THE INVENTION

According to embodiments of the present invention, in an information processing apparatus for creating support data to support a user to enable reproduction, editing or retrieval in an operation desired by the user when the user reproduces, edits or retrieves use object data including video/audio data or only audio data, the information processing apparatus includes an audio data acquisition processor to acquire only audio data as use object audio data from the use object data, a key data management processor to record key data including audio pattern data as a retrieval key for a matching, a key matching processor to check the use object audio data against the audio pattern data based on a specified condition and to obtain matching result information indicating a position satisfying the specified condition in the use object audio data, and a matching result recording instruction processor to record the match result information as the support data onto a recording medium.

According to embodiments of the present invention, an audio period similar to an audio of a previously specified period in key audio data or an audio pattern previously cut out from the key audio data and feature-extracted is detected from the use object audio data, the division point and the control point are determined in accordance with the attribute held by the retrieval key and on the basis of one of or both of the starting and terminal ends of the detected (audio) period in the use object audio data, and a previously specified name or a name given in accordance with a previously specified naming method is set to a period before or after the division, the control point or the whole use object audio data.

Accordingly, according to embodiments of the present invention, a specific pattern audio appearing each time, such as a corner title music, is made a key, and reproduction is performed from its head, the title music is skipped and reproduction is performed from the main part of a corner, a corner name is given to its time point or a divided chapter, or a program name including this corner is given.

### BRIEF DESCRIPTION OF THE DRAWINGS

FIG. 1 is a block diagram showing a structure of a first embodiment of a video/audio processing apparatus of the invention.

FIG. 2 is a table showing an example of information, together with retrieval keys, managed in a key data management part 10 of the first embodiment.

FIG. 3 is a table showing an example of operations made to correspond to attributes and regulated in a matching result recording instruction part 35 of the first embodiment.

FIG. 4 is a schematic view showing an example of information recorded in accordance with a regulated operation of “BGM attribute 1” in the matching result recording instruction part 35 of the first embodiment.

FIG. 5 is a schematic view showing an example of information recorded in accordance with a regulated operation of “opening music attribute 1” in the matching result recording instruction part 35 of the first embodiment.

FIG. 6 is a schematic view showing an example of information recorded in accordance with a regulated operation of “corner music attribute 1” in the matching result recording instruction part 35 of the first embodiment.

FIG. 7 is a schematic view showing an example of information recorded in accordance with a regulated operation of “competition start event attribute 1” in the matching result recording instruction part 35 of the first embodiment.

FIG. 8 is a block diagram showing a structure of a second embodiment of an audio processing apparatus of the invention.

FIG. 9 is a table showing an example of information, together with retrieval keys, managed in a key data management part 10 of the second embodiment.

FIG. 10 is a table showing an example of an operation made to correspond to an attribute and regulated in a matching result recording instruction part 35 of the second embodiment.

FIG. 11 is a block diagram showing a structure of a third embodiment of a video/audio processing apparatus of the invention.

FIG. 12 is a block diagram showing a structure of a fourth embodiment of an audio processing apparatus of the invention.

FIG. 13 is a block diagram showing a structure of a fifth embodiment of a video/audio processing apparatus of the invention.

FIG. 14 is a block diagram showing a structure of a sixth embodiment of an audio processing apparatus of the invention.

FIG. 15 is a block diagram showing a structure of a seventh embodiment of a video/audio processing apparatus of the invention.

FIG. 16 is a block diagram showing a structure of an eighth embodiment of an audio processing apparatus of the invention.

FIG. 17 is a view showing an example of metadata recorded on a recording medium by a matching result recording instruction part when a retrieval key A is detected in a key matching part.

FIG. 18 is a view showing an example of metadata recorded on a recording medium by the matching result recording instruction part when a retrieval key B is detected in the key matching part.

### DETAILED DESCRIPTION OF THE INVENTION

Hereinafter, embodiments of the invention will be described with reference to the drawings.

### First Embodiment

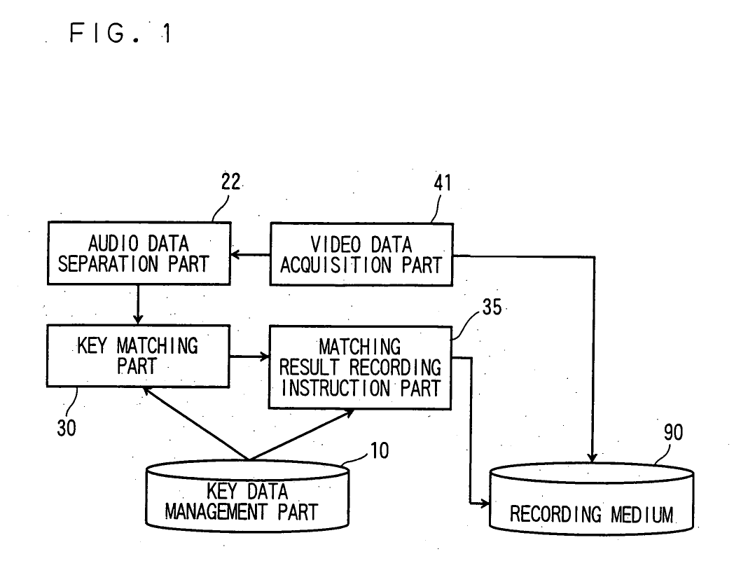

A video/audio processing apparatus according to a first embodiment of the invention will be described with reference to FIGS. 1 to 7.

The video/audio processing apparatus according to this embodiment is an apparatus for recording, based on key data, metadata as support data for reproduction, editing and retrieval into video/audio data as use object data.

In the present specification, “matching” means comparing use object data (video/audio data or audio data) with audio pattern data as a retrieval key and detecting which position or period in the use object data corresponds to the audio pattern data.

(1) Structure of the Video/Audio Processing Apparatus

FIG. 1 shows a structure of the video-audio processing apparatus of this embodiment.

The video/audio processing apparatus shown in FIG. 1 includes a key data management part 10, a video data acquisition part 41, an audio data separation part 22, a key matching part 30, a matching result recording instruction part 35, and a recording medium 90.

(1-1) Key Data Management Part 10

The key data management part 10 manages plural audio pattern data as retrieval keys. Besides, with respect to each of the retrieval keys, information such as a relevant name and an attribute can be managed together as key relevant data.

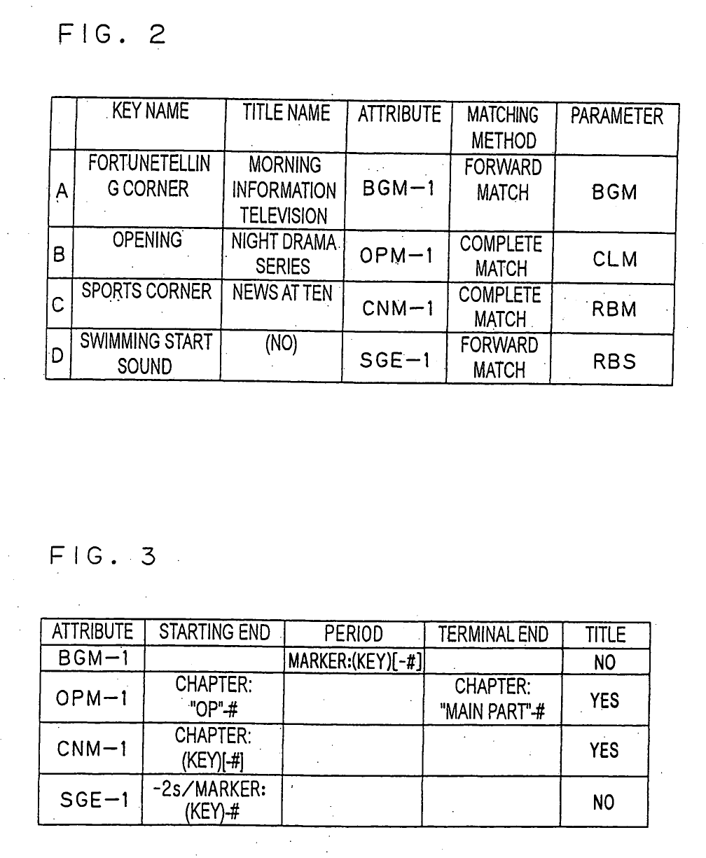

FIG. 2 shows an example of key relevant data managed together with audio pattern data as retrieval keys in the key data management part 10. Here, a name of a key, a name of a title, an attribute, a matching method and a parameter are managed.

With respect to a retrieval key A, information of “fortunetelling corner”, “morning information television”, “BGM attribute 1 (BGM-1)”, “forward match”, and “BGM” is managed.

With respect to a retrieval key B, information of “opening”, “night drama series”, “opening music attribute 1 (OPM-1)”, “complete match”, and “clean music (CLM) ” is managed.

With respect to a retrieval key C, information of “sports corner”, “news at ten”, “corner music attribute 1 (CNM-1) ”, “complete match”, and “robust music (RBM) ” is managed.

With respect to a retrieval key D, information of “swimming start sound”, “(no title)”, “competition start event attribute 1 (SGE-1)”, “forward match”, and “robust effect sound (RBS) ” is managed.

The “attribute” is for regulating a recording instruction operation as to how the support data is recorded on the recording medium 90 in the after-mentioned matching result recording instruction part 35.

The “matching method” and “parameter” are for regulating a matching algorism in the after-mentioned key matching part 30, and a feature selection and evaluation method. It is assumed that “BGM” in the parameter is such that a human voice such as narration is main and music is superimposed on the background, “clean music (CLM) ” is such that only music exists and irrelevant human voice and the like are not superimposed, “robust music (RMB) ” is such that music is main and some noise and the like are contained, and “robust effect sound (RBS) ” is especially a short effect sound and is such that some noise and the like are contained.

The audio pattern data in the key data management part 10 is held such that the key matching part 30 can make reference with respect to audio given by a not-shown external audio pattern acquisition unit or audio cut out while a period is specified. For example, it may be reproducible sound data, or may be such that audio data is feature-extracted and is made a parameter.

Incidentally, although it is assumed that the information, together with the retrieval key, is previously set and managed, when selection and setting is made to the key matching part 30 for actual detection and retrieval, part or all of the information may be changed and used. For example, although the retrieval key B is generally “complete match” and “clean music (CLM)”, when it is used as “forward match” and “BGM”, it becomes suitable for retrieval and detection of a trailer of the same program.

(1-2) Video Data Acquisition Part 41

The video data acquisition part 41 acquires video/audio data inputted from an external digital video camera, a receiving tuner of digital broadcast or the like, or another digital equipment, and records it on the recording medium 90, and further delivers it to the audio data separation part 22. Besides, an analog video/audio signal inputted from an external video camera, a broadcast receiving tuner, or another equipment is acquired, and after it is converted into digital video/audio data, it may be recorded on the recording medium 90, or may be delivered to the audio data separation part 22.

Incidentally, in addition to these processings, as the need arises, a decryption processing of the video/audio data (for example, B-CAS; BS Conditional Access System), a decode processing (for example, MPEG2), a format conversion processing (for example, TS/PS), a rate (compression rate) conversion processing and the like may be performed.

(1-3) Audio Data Separation Part 22

The audio data separation part 22 separates audio data from the video/audio data acquired in the video data acquisition part 41 and delivers it to the key matching part 30.

(1-4) Key Matching Part 30

The key matching part 30 checks previously selected one or plural audio pattern data among the audio pattern data managed as the retrieval keys in the key data management part 10 against the audio data separated in the audio data separation part 22, and detects a similar period.

Here, with respect to the retrieval key A, in accordance with the information of “forward match” and “BGM”, an algorism is used in which attention is paid to a music element of BGM, by masking the frequency region of human voice or the like, to evaluate a coincidence degree, and detection is made from the head of the retrieval key to a portion where patterns become coincident while the terminal end is free.

With respect to the retrieval key B, in accordance with the information of “complete match” and “clean music”, an algorithm is used in which importance is attached to a music element to evaluate a coincidence degree, and a place where the whole pattern of the retrieval key becomes coincident is detected.

With respect to the retrieval key C, in accordance with the information of “complete match” and “robust music”, an algorithm is used in which while importance is attached to a music element, some noise is allowed, a coincidence degree is evaluated, and a place where the whole pattern of the retrieval key becomes coincident is detected.

With respect to the retrieval key D, in accordance with the information of “forward match” and “robust effect sound”, an algorithm is used in which attention is paid to a spectral peak to evaluate a coincidence degree, and detection is made from the head of the retrieval key to a portion where patterns become coincident while the terminal end is free.

(1-5) Matching Result Recording Instruction Part 35

The matching result recording instruction part 35 acquires key data detected in the key matching part 30 from the key data management part 10. In accordance with the attribute of a retrieval key in the key data, metadata is recorded on the recording medium 90 so that reproduction, editing and retrieval can be easily performed. The metadata recorded on the recording medium 90 has a structure regulated by, for example, the VR (Video Recording) mode of DVD (Digital Versatile Disc).

FIG. 3 shows an example of recording instruction operations made to correspond to the attributes and regulated in the matching result recording instruction part 35.

With respect to “BGM attribute 1 (BGM-1)”, the matching result recording instruction part 35 performs a recording instruction operation to the recording medium 90, so that the whole detected period is made a marker period as it is, and the name of the period is set as “(name of key)” (in the case where plural periods are detected, “(name of key)—number”), and the recording medium 90 records it as metadata based on the recording instruction operation. Incidentally, “#” in FIG. 3 denotes a number.

With respect to “opening music attribute 1 (OPM-1)”, the matching result recording instruction part 35 performs a recording instruction operation to the recording medium 90, so that a chapter division is made at the starting end and the terminal end of a detected period, the name of a chapter sandwiched between the starting and terminal ends is set as “[opening]—number”, the name of a backward chapter, when a division is made at the terminal end, is set as “[main part]—number”, and in case a title name has not been set, “name of title” related to the key is set as the title name, and the recording medium 90 makes a record as the metadata based on the recording instruction operation.

With respect to “corner music attribute 1 (CNM-1)”, the matching result recording instruction part 35 performs a recording instruction operation to the recording medium 90, so that a chapter division is made at the starting end of a detected period, the name of a backward chapter of the division is set as “(name of key)” (in the case where plural periods are detected, “(name of key)—number”), and in case a title name has not been set, “name of title” related to the key is set as the title name, and the recording medium 90 makes a record as the metadata based on the recording instruction operation.

With respect to “competition start event attribute 1 (SGE-1)”, the matching result recording instruction part 35 performs a recording instruction operation to the recording medium 90, so that a point two seconds before the starting of a detected period is made a marker point, and the name of the marker is set as “(name of key)—number”, and the recording medium 90 makes a record as the metadata based on the recording instruction.

Incidentally, the metadata is recorded on the recording medium 90, and at the same time, it can be outputted to be displayed on an external display device. In this display device, when the video/audio data or video/audio signals acquired in the video data acquisition part 41 are displayed, what can be displayed among the metadata is extracted and displayed, or can also be held on the recording medium so that it can be displayed in accordance with a display instruction operation from the user.

Besides, the video/audio data or metadata recorded on the recording medium 90 is subjected to time-shift reproduction processing at the same time as the recording processing, so that a similar display can also be performed.

(2) Recording Instruction Operation When Retrieval Key A is Detected

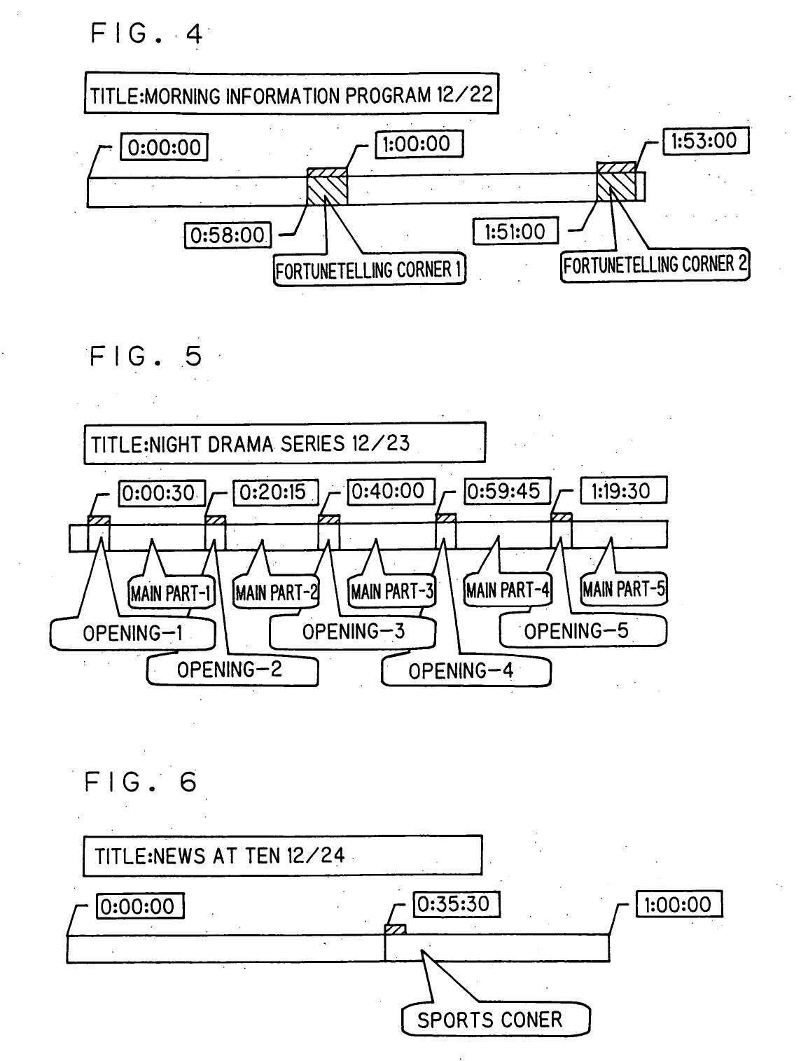

When the retrieval key A is detected in the key matching part 30, the matching result recording instruction part 35 performs a recording instruction operation to the recording medium 90 in accordance with the regulated operation of “BGM attribute 1”, and FIG. 4 is a schematic view showing information recorded on the recording medium 90.

The period of the “fortunetelling corner” in the “morning information television” program (1 hour and 54 minutes) broadcast on December 22 is detected twice at a time of 58 minutes from the start of the broadcast and at a time of 1 hour and 51 minutes (indicated by dense marks on a band), and markers (portions indicated by oblique lines in the band) of names “fortunetelling corner 1” and “fortunetelling corner 2” are given.

By this, it becomes possible that for example, only the portion of the fortunetelling corner is extracted, is re-encoded at high compression, and is transferred to a portable equipment.

(3) Recording Instruction Operation When Retrieval Key B is Detected

When the retrieval key B is detected in the key matching part 30, the matching result recording instruction part 35 performs a recording instruction operation to the recording medium 90 in accordance with the regulated operation of “opening music attribute 1”, and FIG. 5 is a schematic view indicating information recorded on the recording medium 90.

The period of “opening” in the five-story series rebroadcast program (1 hour and 40 minutes) of “night drama series” broadcast on December 23 is detected five times in total at a time of 0 minute and 30 seconds, a time of 20 minutes and 15 seconds and the like (indicated by dense marks on a band), and divisions (indicated by vertical lines in the band) are made into a chapter (no name) before first “opening”, and chapters such as first “opening-1”, “main part-1” subsequent to the first opening, second “opening-2”, “main part-2” subsequent to the second opening, and the like. Besides, the title name “night drama series” is set. Here, in relation to the retrieval key B, in case genre “drama”, storage destination medium “HDD”, storage destination folder “my drama”, and final storage rate (compression rate) “low” are set in addition to the title name, when the retrieval key B is detected, instead of the title name or in addition to the title name, the genre “drama” may be set, the storage destination disk may be made “my drama” folder of the HDD, or the storage may be made after conversion to the “low” rate in which the quality is lowered in accordance with the final storage rate.

By this, for example, in the case where only the third story of the rebroadcast on Wednesday is desired to be watched, “opening-3” is selected from the chapter list and is reproduced, or by performing an operation of “jump to next chapter” during the opening reproduction, only the main parts can be collectively watched without watching the same opening many times. Besides, title name setting independent on the EPG, and the automation of genre setting, storage destination folder setting and the like become possible.

(4) Recording Instruction Operation When Retrieval Key C is Detected

When the retrieval key C is detected in the key matching part 30, the matching result recording instruction part 35 performs a recording instruction operation to the recording medium 90 in accordance with the regulated operation of “corner music attribute 1”, and FIG. 6 is a schematic view showing information recorded on the recording medium 90.

The music of “sports corner” in “news at ten” (60 minutes) broadcast on December 24 is detected, a chapter division is made at the head (35 minutes and 30 seconds) of the corner music, and the chapter name of “sports corner” is given. By this, for example, the user interested in only sports can select and reproduce “sports corner” from the chapter list.

Besides, it becomes possible to perform viewing and listening in such a manner that after the main news is watched for a while from the head of the program, when interest is lost, an operation of “jump to next chapter” or the like is performed, so that a halfway portion to the “sports corner” is omitted.

(5) Recording Instruction Operation When Retrieval Key D is Detected

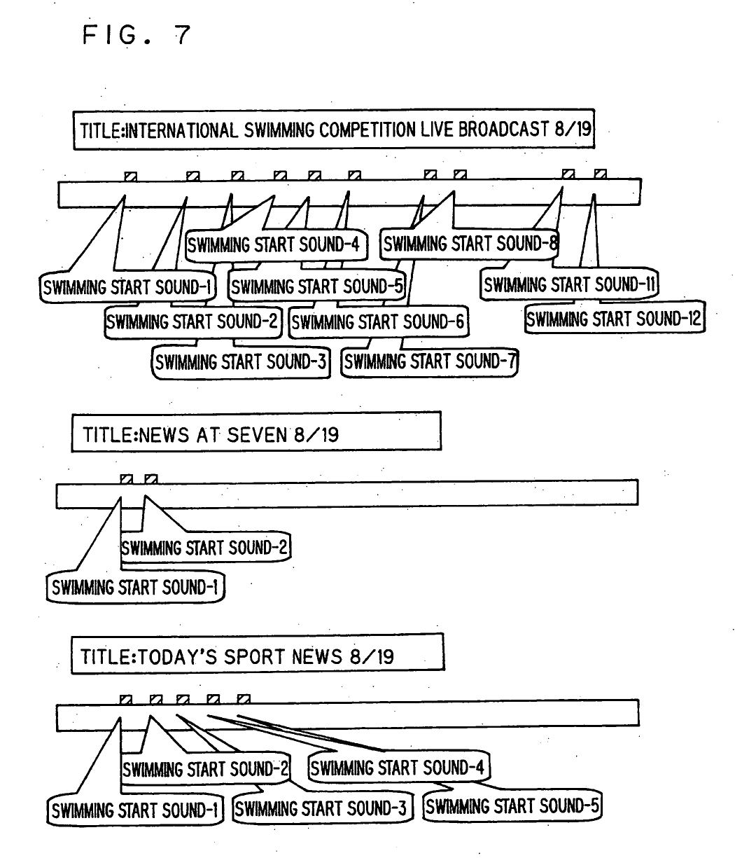

When the retrieval key D is detected in the key matching part 30, the matching result recording instruction part 35 performs a recording instruction operation to the recording medium 90 in accordance with the regulated operation of “competition start event attribute 1”, and FIG. 7 is a schematic view showing information recorded on the recording medium 90.

The “swimming start sound” in the “international swimming competition live broadcast” program broadcast on August 19 is detected twelve times, is detected twice in the “news at seven” program broadcast on the same day, and is detected five times in the “today's sports news” program, and a marker such as “swimming start sound-1” or “swimming start sound-2” is given to a portion two seconds before each of them.

By this, the scene of the start of each race can be accessed by performing the operation of “jump to next marker” or the like. For example, in the case where there is a race desired to be watched since a specific player enters, it becomes possible that a jump is successively made while watching the reproduced video, and the desired race is found.

### Second Embodiment

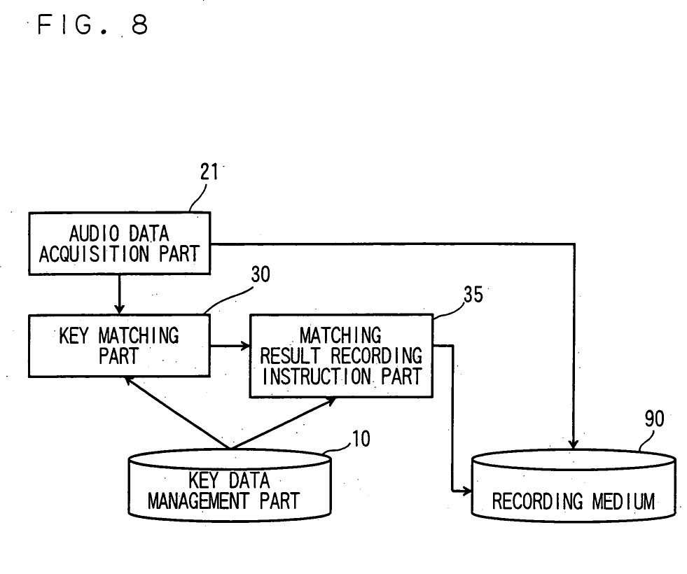

An audio processing apparatus according to a second embodiment of the invention will be described with reference to FIGS. 8 to 10.

A different point between this embodiment and the first embodiment is that although the video/audio data is processed in the first embodiment, only audio data is processed in this embodiment.

(1) Structure of Audio Processing Apparatus

FIG. 8 shows a structure of the audio processing apparatus according to this embodiment.

The audio processing apparatus shown in FIG. 8 includes a key data management part 10, an audio data acquisition part 21, a key matching part 30, a matching result recording instruction part 35 and a recording medium 90. Differently from the first embodiment, video data is not treated.

(1-1) Key Data Management 10

Similarly to the first embodiment, the key data management part 10 manages plural audio pattern data as retrieval keys. Besides, with respect to the respective retrieval keys, information of relevant names, attributes and the like can be managed together.

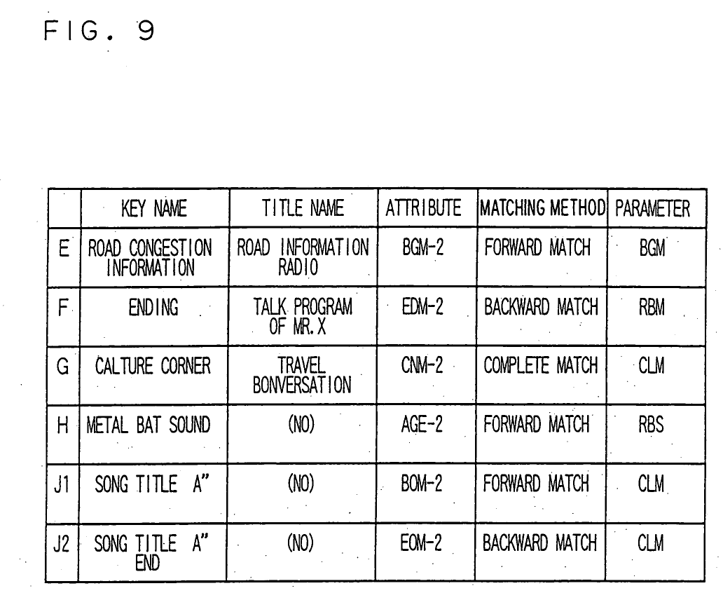

FIG. 9 shows an example of key relevant data as information, together with audio pattern data as retrieval keys, managed in the key data management part 10 of the second embodiment. Here, a name of a key, a name of a title, an attribute, a matching method, and a parameter are managed as key relevant data.

With respect to a retrieval key E, it is assumed that the information of “road congestion information”, “road information radio”, “BGM attribute 2 (BGM-2)”, “forward match”, and “BGM” is managed.

With respect to a retrieval key F, the information of “ending”, “talk program of Mr. “X”, “ending music attribute 2 (EDM-2)”, “backward match” and “robust music (RBM)” is managed.

With respect to a retrieval key G, the information of “culture corner”, “travel conversation”, “corner music attribute 2 (CNM-2)”, “complete match” and “clean music (CLM)” is managed.

With respect to a retrieval key H, the information of “metal bat sound”, “(no title)”, “competition noted event attribute 2 (AGE-2)”, “forward match”, and “robust effective sound (RBS) ” is managed.

Further, with respect to retrieval keys J1 and J2 operating in a pair, the information of “song title “A””, “(no title)”, “beginning of music attribute 2 (BOM-2)”, “forward match” and “clean music (CLM)”, and “song title “A” end”, “(no title)”, “end of music attribute 2 (EOM-2)”, “backward match” and “clean music (CLM)” are respectively managed.

(1-2) Audio Data Acquisition Part 21

The audio data acquisition part 21 acquires audio data inputted from an external digital microphone, a receiving tuner of digital broadcast or the like, or another digital equipment, records it on the recording medium 90, and delivers it to the key matching part 30. Besides, an analog audio signal inputted from an external microphone, a broadcast receiving tuner, or another equipment is acquired, and after it is convert into digital audio data, it may be record on the recording medium 90 or delivered to the key matching part 30.

Incidentally, as the need arises, a decryption processing of audio data, a decode processing, a format conversion processing, a rate conversion processing or the like may be performed in addition to these processings.

(1-3) Key Matching Part 30

The key matching part 30 checks previously selected one or plural audio pattern data among the audio pattern data managed as the retrieval keys in the key data management part 10 against the audio data acquired in the audio data acquisition part 21, and detects a similar period.

With respect to the retrieval key E, in accordance with the information of “forward match” and “BGM”, an algorithm is used in which attention is paid to the music element of the BGM, by masking the frequency region of human voice or the like, to evaluate a coincidence degree, and detection is made from the head of the retrieval key to a portion where patterns become coincident while the terminal end is free.

With respect to the retrieval key F, in accordance with the information of “backward match” and “robust music”, an algorithm is used in which while importance is attached to a music element, some noise is allowed, and a coincidence degree is evaluated, and detection is made from the end of the retrieval key to a portion where patterns become coincident while the starting end is free.

With respect to the retrieval key G, in accordance with the information of “complete match” and “clean music”, an algorithm is used in which importance is attached to a music element to evaluate a coincidence degree, and a place where the whole pattern of the retrieval key becomes coincident is detected.

With respect to the retrieval key H, in accordance with the information of “forward match” and “robust effect sound”, an algorithm is used in which attention is paid to a spectral peak to evaluate a coincidence degree, and detection is made from the head of the retrieval key to a portion where patterns become coincident while the terminal end is free.

With respect to the retrieval key J1, in accordance with the information of “forward match” and “clean music”, an algorithm is used in which importance is attached to a music element to evaluate a coincidence degree, and detection is made from the head of the retrieval key to a portion where patterns become coincident while the terminal end is free.

With respect to the retrieval key J2, in accordance with the information of “backward match” and “clean music”, an algorithm is used in which importance is attached to a music element to evaluate a coincidence degree, and detection is made from the end of the retrieval key to a portion where patterns become coincident while the starting end is free.

(1-4) Matching Result Recording Instruction Part 35

The matching result recording instruction part 35 acquires key data detected in the key matching part 30 from the key data management part 10. Then, in accordance with the attribute of the retrieval key in this key data, metadata is recorded on the recording medium 90 so that reproduction, editing and retrieval can be easily performed.

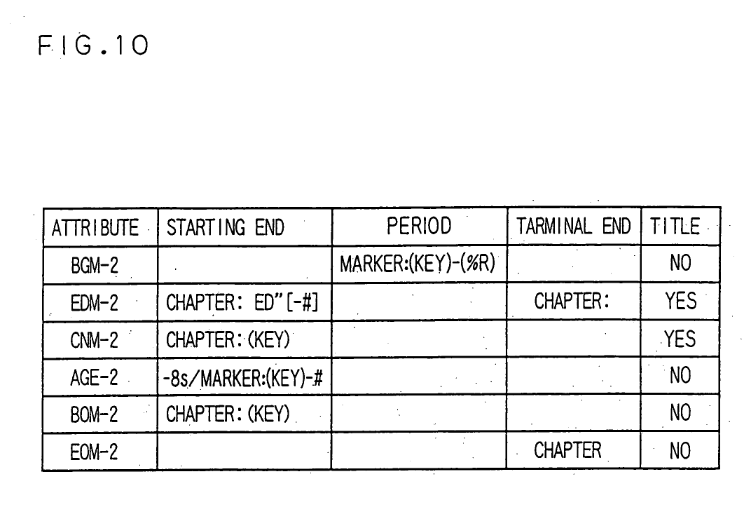

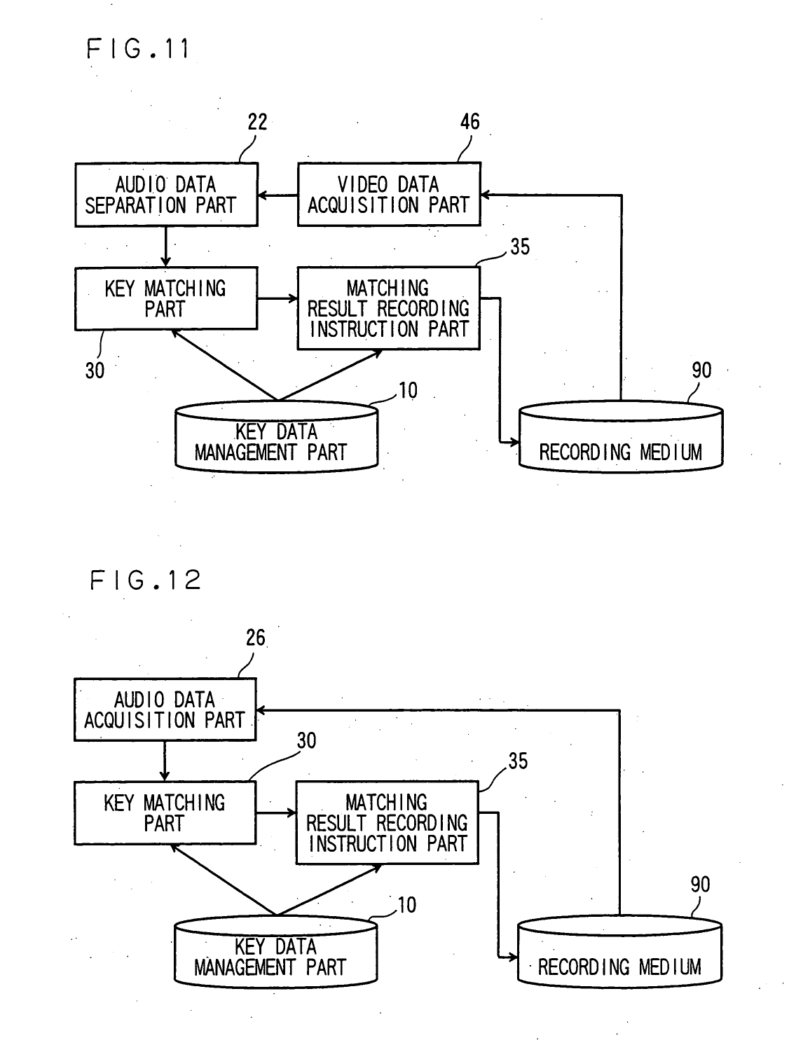

FIG. 10 shows an example of recording instruction operations made to correspond to attributes and regulated in the matching result recording instruction part 35.

With respect to “BGM attribute 2 (BGM-2)”, the matching result recording instruction part 35 performs a recording instruction operation to the recording medium 90, so that the whole detected period is made a marker period as it is, the broadcast time of a detected place is acquired as “HH:MM” (00 to 23 hours, 00 to 59 minutes), and then, the name of the period is set as “(name of key)—time”, and the recording medium 90 makes a record as metadata based on the recording instruction operation.

With respect to “ending music attribute 2 (EDM-2)”, the matching result recording instruction part 35 performs a recording instruction operation to the recording medium 90, so that a chapter division is made at the starting end and the terminal end of a detected period, the name of a chapter sandwiched between the starting and terminal ends is made “[ending]” (in the case where plural periods are detected, “[ending]—number”), and in case a title name has not been set, “name of title” related to the key is set as the title name, and the recording medium 90 makes a record as metadata based on the recording instruction operation.

With respect to “corner music attribute 2 (CNM-2)”, the matching result recording instruction part 35 performs a recording instruction operation to the recording medium 90, so that a chapter division is made at the starting end of a detected period, the name of a divided backward chapter is made “(name of key)”, and in case a title name has not been set, “name of title” related to the key is set as the title name, and the recording medium 90 makes a record as metadata based on the recording instruction operation.

With respect to “competition noted event attribute 2 (AGE-2)”, the matching result recording instruction part 35 performs a recording instruction operation to the recording medium 90, so that a point eight seconds before the starting end of a detected period is made a marker point, and the name of a marker is set as “(name of key)—number”, and the recording medium 90 makes a record as metadata based on the recording instruction operation.

With respect to “beginning of music attribute 2 (BOM-2)”, the matching result recording instruction part 35 performs a recording instruction operation to the recording medium 90, so that a chapter division is made at the starting end of a detected period, and the name of a divided backward chapter is set as “(name of key)”, and the recording medium 90 makes a record as metadata based on the recording instruction operation.

With respect to “end of music attribute 2 (EOM-2)”, the matching result recording instruction part 35 performs a recording instruction operation to the recording medium 90, so that a chapter division is made at the terminal end of a detected period, and the recording medium 90 makes a record as metadata based on the recording instruction operation.

(2) Recording Instruction Operation When Retrieval Key E is Detected

In the structure as stated above, for example, when the retrieval key E is detected, in accordance with the regulated recording instruction operation of “BGM attribute 2”, the period of “road congestion information” in the “road information radio” program is detected plural times, and in accordance with the time of the broadcast, markers of names of “road congestion information—9:55”, “road congestion information—10:28”, “road congestion information—10:56” and the like are attached to the detected periods.

By this, for example, it becomes possible to extract only the road congestion information from the newest information in sequence and to listen to it.

(3) Recording Instruction Operation When Retrieval Key H is Detected

When the retrieval key H is detected, “metal bat sound” in the “high school baseball tournament” program is detected in accordance with the regulated operation of “competition noted event attribute 2”, and since a marker is put eight seconds before each detected place, it becomes possible to sequentially reproduce only the batting scene from the immediately preceding pitching motion.

(4) Recording Instruction Operation When Retrieval Keys J1 and J2 are Detected

When the retrieval keys J1 and J2 are detected, in accordance with the combination of the regulated operations of “beginning of music attribute 2” and “end of music attribute 2”, a chapter division is made at both the beginning and the end of the music of “song title “A””, and the period of the music becomes the chapter of “song title “A””.

### Third embodiment

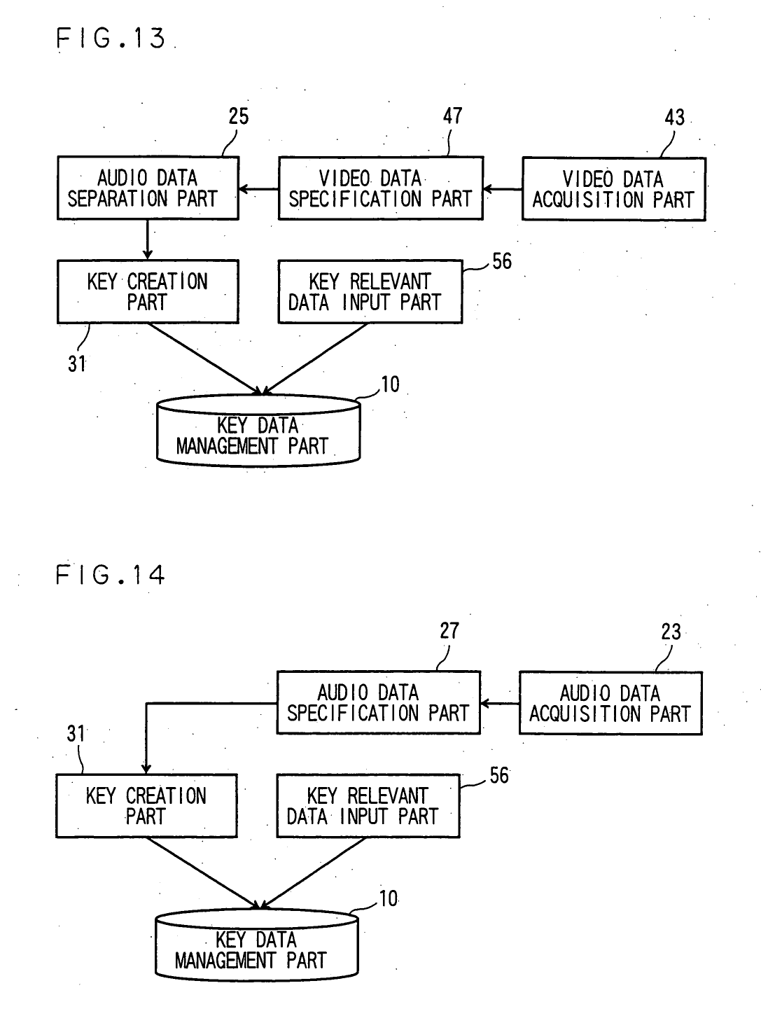

A video/audio processing apparatus according to a third embodiment of the invention will be described with reference to FIG. 11.

A different point between this embodiment and the first embodiment is that in the first embodiment, the recording and processing is performed on the video/audio data acquired from the outside, while in this embodiment, the processing is performed on video/audio data which has already been recorded.

FIG. 11 shows a structure of the video/audio processing apparatus of this embodiment.

The video/audio processing apparatus shown in FIG. 11 includes a key data management part 10, a video data acquisition part 46, an audio data separation part 22, a key matching part 30, a matching result recording instruction part 35, and a recording medium 90.

Similarly to the first embodiment, the key data management part 10 manages plural audio pattern data as retrieval keys. Besides, with respect to the respective retrieval keys, information of relevant names, attributes and the like can be managed together.

For example, as shown in FIG. 2, with respect to the retrieval key A, ┌fortunetelling corner┘, ┌morning information television┘, ┌BGM attribute 1┘ and the like, with respect to the retrieval key B, ┌opening┘, ┌night drama series┘, ┌opening music attribute 1┘ and the like are managed as the key relevant information.

Video/audio data or video/audio signals are previously recorded on the recording medium 90.

The video data acquisition part 46 reads and acquires the video/audio data recorded on the recording medium 90, and delivers it to the audio data separation part 22. Besides, an analog video/audio signal is read and acquired, and after it is converted into digital video/audio data, it may be delivered to the audio data separation part 22.

Incidentally, as the need arises, a decryption processing of the video/audio data, a decode processing, a format conversion processing, a rate conversion processing and the like may be performed in addition to these processings. Incidentally, a different point from the video data acquisition part 41 in the first embodiment is that the recording and processing is not performed on the data acquired from the outside, but the processing is performed on the data which has already been recorded.

The audio data separation part 22 separates audio data from the video/audio data acquired in the video data acquisition part 46 and delivers it to the key matching part 30. For example, MPEG2 data is demuxed to extract MPEG2 Audio ES including the audio data, and is decoded (AAC or the like).

The key matching part 30 checks previously selected one or plural audio pattern data among the audio pattern data managed as the retrieval keys in the key data management part 10 against the audio data separated in the audio data separation part 22, and detects a similar period.

The matching result recording instruction part 35 acquires the key data detected in the key matching part 30 from the key data management part 10. Then, in accordance with the attribute of the retrieval key in this key data, metadata is recorded on the recording medium 90 so that reproduction, editing and retrieval can be easily performed.

Similarly to FIG. 3, recording instruction operations are regulated for the respective attributes, for example, with respect to ┌BGM attribute 1┘ of the retrieval key A, the whole detected period is set as ┌(name of key)┘, with respect to ┌opening music attribute 1┘ of the retrieval key B, a portion between the starting and terminal ends of the detected period is set as ┌opening┘, a backward period of the terminal end is set as ┌main part┘, and the title name is set.

Besides, in the matching result recording instruction part 35, the metadata recorded on the recording medium 90 has a structure regulated by, for example, ARIB STD-B38.

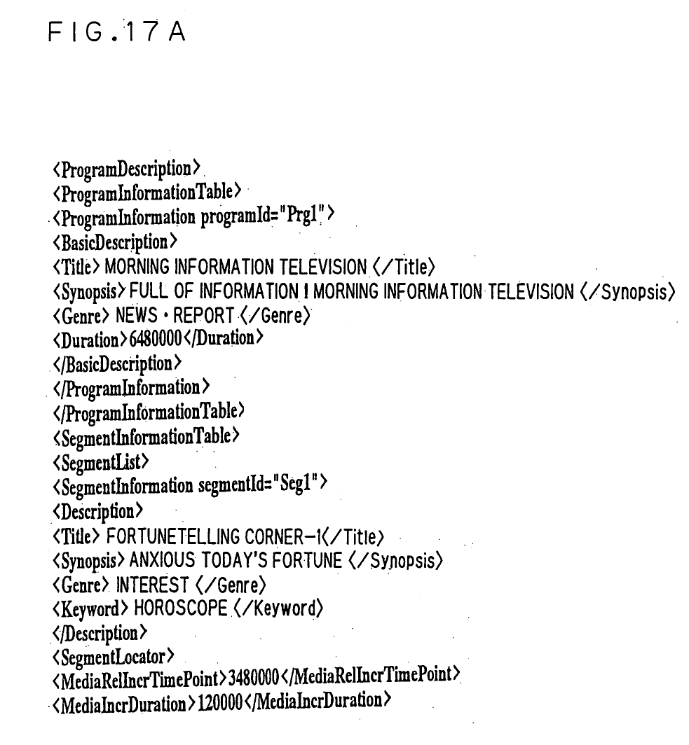

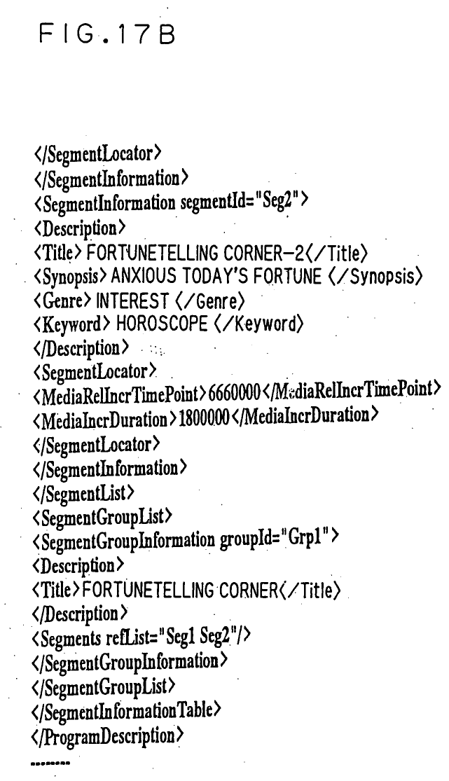

FIG. 17 shows an example of metadata recorded on the recording medium 90 by the matching result recording instruction part 35 when the retrieval key A is detected in the key matching part 30. Two segments of ┌fortunetelling corner-1┘of 120 seconds from 3480 second (58 minutes) after the start of the program and ┌fortunetelling corner-2┘ of 180 seconds from 6660 seconds (1 hour 51 minutes), and a segment group of ┌fortunetelling corner┘ in which these fortunetelling corners are extracted are recorded.

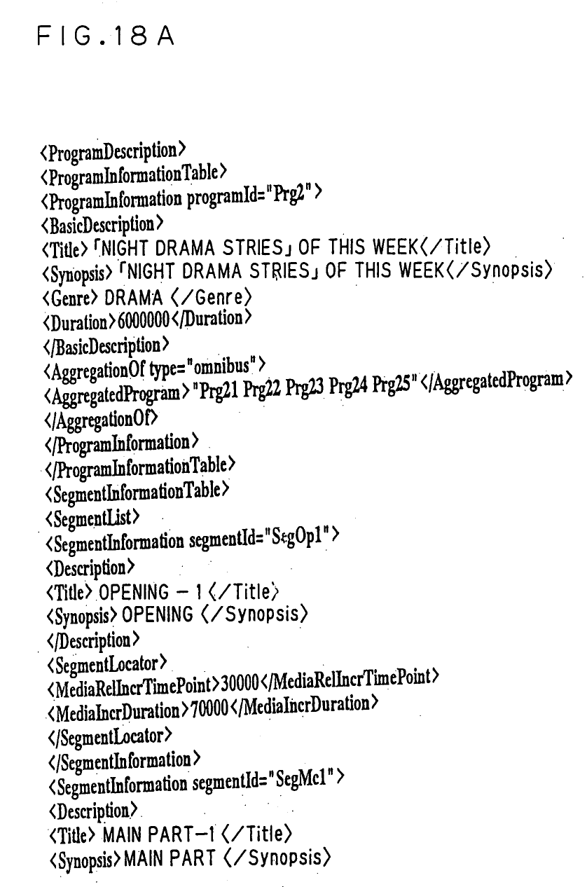

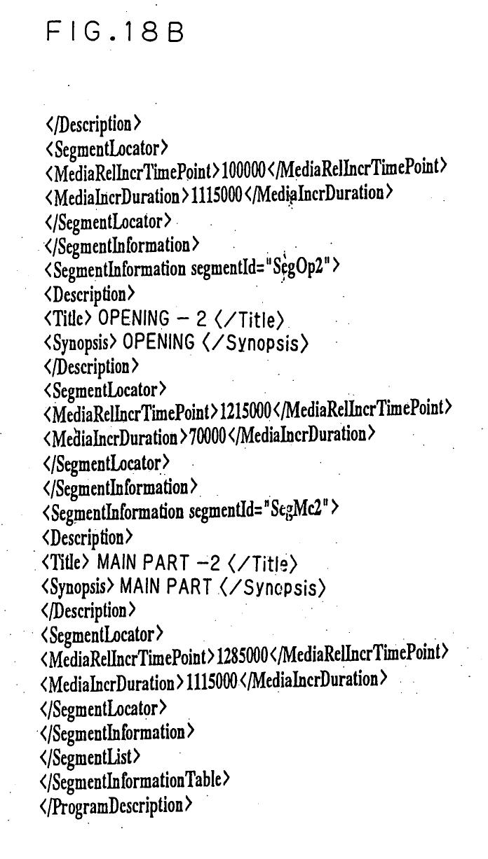

FIG. 18 shows an example of metadata recorded on the recording medium 90 by the matching result recording instruction part 35 when the retrieval key B is detected in the key matching part 30. With respect to the program, the information of the name (title name) ┌night drama series┘, genre 539 drama┘ and the like, and segments of ┌opening-1┘ of 70 seconds from 30 seconds after the start of the program, ┌opening-2┘ from 1215 seconds (20 minutes and 15 seconds), ┌main part-1┘ and ┌main part-2┘ between them, and the like are recorded.

### Fourth Embodiment

An audio processing apparatus according to a fourth embodiment of the invention will be described with reference to FIG. 12.

A different point between this embodiment and the second embodiment is that in the second embodiment, the recording and processing is performed on the data acquired from the outside, while in this embodiment, the processing is performed on data which has already been recorded.

FIG. 12 shows a structure of the audio processing apparatus of this embodiment.

The audio processing apparatus shown in FIG. 12 includes a key data management part 10, an audio data acquisition part 26, a key matching part 30, a matching result recording instruction part 35, and a recording medium 90. Differently from the third embodiment, video data is not treated.

Similarly to the second embodiment, the key data management part 10 manages plural audio pattern data as retrieval keys. Besides, with respect to the respective retrieval keys, information of relevant names, attributes and the like can be managed together.

Audio data, audio signals, or video/audio signals are previously recorded on the recording medium 90.

The audio data acquisition part 26 reads and acquires the audio data recorded on the recording medium 90 and delivers it to the key matching part 30. Besides, the audio data acquisition part 26 reads and acquires the analog audio signal recorded on the recording medium 90, or reads the analog video/audio signal recorded on the recording medium 90 and acquires only an audio signal, and after it is converted into digital audio data, it may be delivered to the key matching part 30. Incidentally, as the need arises, a decryption processing of the audio data, a decode processing, a format conversion processing, a rate conversion processing and the like may be performed in addition to these processings. Incidentally, a different point from the audio data acquisition part 21 in the second embodiment is that the recording and processing is not performed on data acquired from the outside, but the processing is performed on the data which has already been recorded.

The key matching part 30 checks previously selected one or plural audio pattern data among the audio pattern data managed as the retrieval keys in the key data management part 10 against the audio data acquired in the audio data acquisition part 26, and detects a similar period.

The matching result recording instruction part 35 acquires the key data detected in the key matching part 30 from the key data management part 10. Then, in accordance with the attribute of the retrieval key in this key data, metadata is recorded on the recording medium 90 so that reproduction, editing and retrieval can be easily performed.

### Fifth Embodiment

A video/audio processing apparatus according to a fifth embodiment of the invention will be described with reference to FIG. 13.

In this embodiment, the video/audio processing apparatus for creating keys recorded as retrieval keys in the key data management part 30 of the first to fourth embodiments will be described.

FIG. 13 shows a structure of the video/audio processing apparatus of this embodiment.

The video/audio processing apparatus shown in FIG. 13 includes a video data acquisition part 43, a video data specification part 47, an audio data separation part 25, a key creation part 31, a key relevant data input part 56 and a key data management part 10.

The video data acquisition part 43 acquires video/audio data inputted from an external digital video camera, a receiving tuner of digital broadcast or the like, or another digital equipment, and delivers it to the video data specification part 47. Besides, an analog video/audio signal inputted from an external video camera, a broadcast receiving tuner, or another equipment is acquired, and after it is converted into digital video/audio data, it may be delivered to the video data specification part 47.

In the video data specification part 47, the whole or partial period of the video/audio data acquired in the video data acquisition part 43 is specified by the user. In the case where the specified period is acquired by the operation of the user, it is conceivable to use a device such as, for example, a mouse or a remote control, however, another method may be used. The video/audio data is reproduction-displayed, and the period may be manually specified while the user confirms the video/audio data.

The audio data separation part 25 separates audio data from the video/audio data specified in the video data specification part 47, and delivers it to the key creation part 31.

The key creation part 31 creates audio pattern data used in the key matching part 30 of the first to fourth embodiments with respect to the audio data delivered from the audio data separation part 25.

The key relevant data input part 56 externally inputs key relevant data other than, for example, the audio pattern data as shown in FIG. 2 among what are managed as the retrieval keys in the key data management part 10.

Incidentally, the key relevant data input part 56 may acquire the key relevant data corresponding to the period of the video/audio data specified in the video data specification part 47 from an external system which makes it correspond to the video/audio data inputted to the video data acquisition part 43 and manages it. For example, the title name corresponding to the specified video/audio data, the chapter name corresponding to the specified period, or the like may be acquired from EPG or metadata.

The key data management part 10 manages the audio pattern data created in the key creation part 31 and the key relevant data inputted in the key relevant data input part 56.

### Sixth Embodiment

An audio processing apparatus according to a sixth embodiment of the invention will be described with reference to FIG. 14.

In this embodiment, the audio processing apparatus for creating keys recorded as retrieval keys in the key data management part 30 of the first to fourth embodiments will be described. A different point between this embodiment and the fifth embodiment is that in the fifth embodiment, video/audio data is processed, while in this embodiment, only audio data is processed.

FIG. 14 shows a structure of the audio processing apparatus of this embodiment.

The audio processing apparatus shown in FIG. 14 includes an audio data acquisition part 23, an audio data specification part 27, a key creation part 31, a key relevant data input part 56 and a key data management part 10.

The audio data acquisition part 23 acquires audio data inputted from an external digital microphone, a receiving tuner of digital broadcast or the like, or another digital equipment, and delivers it to the audio data specification part 27. Besides, an analog audio signal inputted from an external microphone, a broadcast receiving tuner, or another equipment is acquired, and after it is converted into digital audio data, it may be delivered to the audio data specification part 27.

The audio data specification part 27 specifies the whole or partial period of the audio data acquired in the audio data acquisition part 23. In the case where the specified period is acquired by the operation of the user, although it is conceivable to use a device such as, for example, a mouse or a remote control, another method may be used. Audio data is reproduced, and a period may be manually specified while the user confirms the audio data.

The key creation part 31 creates the audio pattern data used in the key matching part 30 of the first to fourth embodiments with respect to the audio data delivered from the audio data specification part 27.

The key relevant data input part 56 externally inputs the key relevant data other than, for example, the audio pattern data as shown in FIG. 9 among what are managed as the retrieval keys in the key data management part 10.

Incidentally, the key relevant data input part 56 may acquire the key relevant data corresponding to the period of the audio data specified in the audio data specification part 27 from an external system which makes it correspond to the audio data inputted to the audio data acquisition part 23 and manages it. For example, a title name corresponding to the specified audio data, a chapter name corresponding to the specified period, or the like may be acquired from the EPG or metadata.

The key data management part 10 manages the audio pattern data created in the key creation part 31 and the key relevant data inputted in the key relevant data input part 56.

### Seventh Embodiment

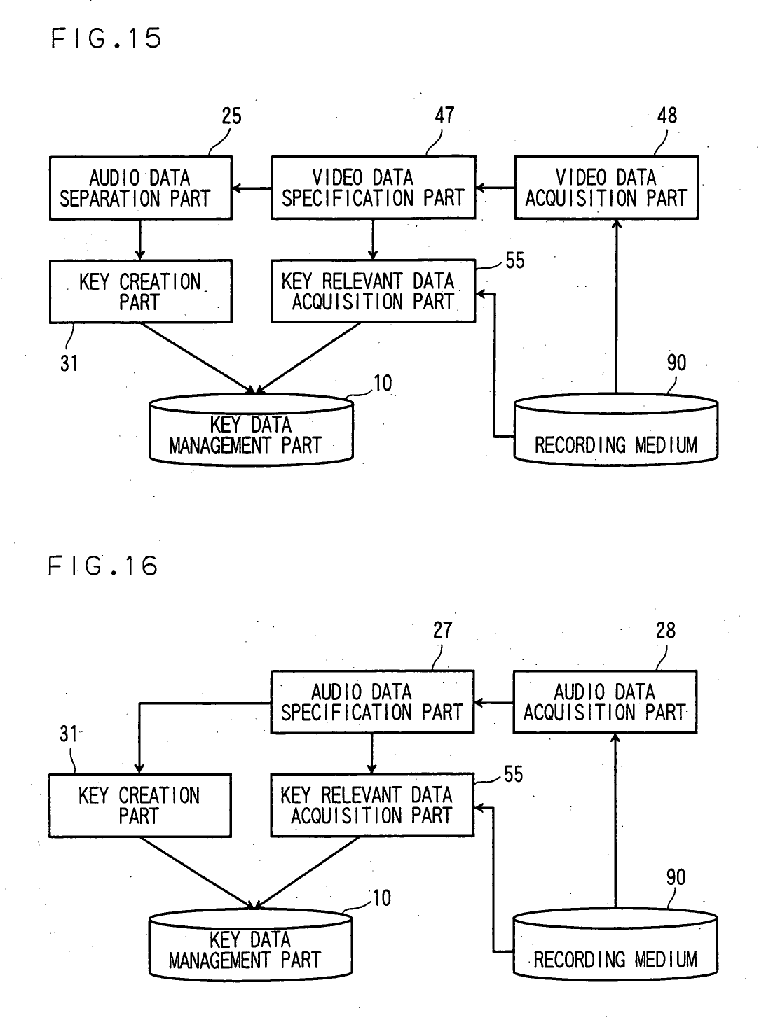

A video/audio processing apparatus according to a seventh embodiment of the invention will be described with reference to FIG. 15.

In this embodiment, the video/audio processing apparatus for creating keys recorded as the retrieval keys in the key data management part 30 of the first to fourth embodiments will be described. A different point between this embodiment and the fifth embodiment is that when there is a title name corresponding to specified video/audio data or a chapter name corresponding to a specified period, those key relevant data are used.

FIG. 15 shows a structure of the video/audio processing apparatus of this embodiment.

The video/audio processing apparatus shown in FIG. 15 includes a recording medium 90, a video data acquisition part 48, a video data specification part 47, an audio data separation part 25, a key creation part 31, a key relevant data acquisition part 55 and a key data management part 10.

Video/audio data or video/audio signals are previously recorded on the recording medium 90. Besides, information for division into units such as titles of video/audio or chapters, and information relating to names of those, attributes and the like are recorded on the recording medium 90.

The video data acquisition part 48 reads and acquires the video/audio data recorded on the recording medium 90, and delivers it to the video data specification part 47. Besides, an analog video/audio signal is read and acquired, and after it is converted into digital video/audio data, it may be delivered to the video data specification part 47.

The video data specification part 47 specifies the whole or partial period of the video/audio data acquired in the video data acquisition part 48. In the case where a specified period is acquired by the operation of the user, although it is conceivable to use a device such as, for example, a mouse or a remote control, another method may be used. Video data is reproduced, and the user may specify the positions of a starting and a terminal ends while confirming the video/audio data. Besides, a chapter is selected from a thumbnail image list of chapters, or the like, and the whole chapter may be regarded as the specified period.

The audio data separation part 25 separates audio data from the video/audio data specified in the video data specification part 47, and delivers it to the key creation part 31.

The key creation part 31 creates audio pattern data used in the key matching part 30 of the first to fourth embodiments with respect to the audio data delivered from the audio data separation part 25.

The key relevant data acquisition part 55 extracts key relevant data corresponding to a period of the video/audio data specified in the video data specification part 47 from the recording medium 90. For example, when there is a title name corresponding to the specified video/audio data or a chapter name corresponding to the specified period, key relevant data of those are extracted. Besides, in the case where the period corresponding to the past retrieval result is specified, and the key data of the retrieval result is stored, the key relevant data as shown in FIG. 2 is extracted. Incidentally, the key relevant data may be externally inputted similarly to the key relevant data input part 56 in the fifth embodiment.

A title name is not limited to a name expressing one program, but may be one expressing a group of plural programs (program group) or one expressing a series of programs (program series). Besides, not the name of a title or a chapter, but an identifier or an attribute value such as a genre may be used as the key relevant data. In addition, when there is information given as the EPG or program metadata, it may be used.

The key data management part 10 manages the audio pattern data created in the creation part 31 and the key relevant data acquired in the key relevant data input acquisition part 55.

### Eighth Embodiment

An audio processing apparatus according to an eighth embodiment of the invention will be described with reference to FIG. 16.

In this embodiment, the audio processing apparatus for creating keys recorded as the retrieval keys in the key data management part 30 of the first to fourth embodiments will be described. A different point between this embodiment and the sixth embodiment is that when there is a title name corresponding to specified audio data or a chapter name corresponding to a specified period, those key relevant data are used.

FIG. 16 shows a structure of the audio processing apparatus of this embodiment.

The audio processing apparatus shown in FIG. 16 includes a recording medium 90, an audio data acquisition part 28, an audio data specification part 27, a key creation part 31, a key relevant data acquisition part 55 and a key data management part 10.

Audio data, audio signals or video/audio signals are previously recorded on the recording medium 90. Besides, information for division into units, such as titles of audio data or chapters, and information relating to those names, attributes and the like are recorded on the recording medium 90.

The audio data acquisition part 28 reads and acquires audio data recorded on the recording medium 90, and delivers it to the audio data specification part 27. Incidentally, the analog audio signal recorded on the recording medium 90 is read and acquired, or the analog video/audio signal recorded on the recording medium 90 is read and only an audio signal is acquired, and after it is converted into digital audio data, it may be delivered to the audio data specification part 27.

The audio data specification part 27 specifies the whole or partial period of the audio data acquired in the audio data acquisition part 28. In the case where the specified period is acquired by the operation of the user, although it is conceivable to use a device such as, for example, a mouse or a remote control, another method may be used. Audio data is reproduced, and the user may specify the positions of a starting and a terminal ends while confirming the audio data. Besides, a chapter is selected from a chapter name list or the like, and the whole chapter may be regarded as the specified period.

The key creation part 31 creates audio pattern data used in the key matching part 30 of the first to fourth embodiments with respect to the audio data delivered from the audio data separation part 27.

The key relevant data acquisition part 55 extracts key relevant data corresponding to a period of the audio data specified in the audio data specification part 27 from the recording medium 90. For example, when there is a title name corresponding to the specified audio data or a chapter name corresponding to the specified period, the key relevant data of those are extracted. Besides, in the case where a period corresponding to a past retrieval result is specified, and the key data of the retrieval result is stored, the key relevant data as shown in FIG. 9 is extracted. Incidentally, the key relevant data may be externally inputted similarly to the key relevant data input part 56 in the sixth embodiment.

The title name is not limited to a name expressing one program, but may be one expressing a group of plural programs (program group) or one expressing a series of programs (program series). Besides, not the name of a title or a chapter, but an identifier or an attribute value such as a genre may be used as the key relevant data. In addition, when there is information given as the EPG or program metadata, it may be used.

The key data management part 10 manages the audio pattern data created in the key creation part 31 and the key relevant data acquired in the key relevant data acquisition part 55.

### Modified Example

The invention is not limited to the respective embodiments, but can be variously modified within the scope not departing from its gist.

For example, in the respective embodiments, although the metadata is used as the support data, another data format may be used as long as the information can support reproduction, editing and retrieval.

What is claimed is:

1. An information processing apparatus for creating support data to support a user to enable reproduction, editing or retrieval in an operation desired by the user when the user reproduces, edits or retrieves use object data including video/audio data or only audio data, comprising:
an audio data acquisition processor to acquire only audio data as use object audio data from the use object data;
a key data management processor to record key data including audio pattern data as a retrieval key for a matching;
a key matching processor to check the use object audio data against the audio pattern data based on a specified condition and to obtain matching result information indicating a position satisfying the specified condition in the use object audio data; and
a recording processor to record the matching result information as the support data onto a recording medium.

2. The information processing apparatus according to claim 1, wherein
the use object data is video/audio data, and
the audio data acquisition processor separates audio data from the use object data and acquires the audio data as the use object audio data.

3. The information processing apparatus according to claim 1, wherein the audio data acquisition processor acquires the use object data from outside and records it onto the recording medium.

4. The information processing apparatus according to claim 1, wherein the audio data acquisition processor reads the use object data from the recording medium.

5. The information processing apparatus according to any one of claims 1 to 4, wherein
the key data includes operation attribute information indicating a creation method of the support data relevant to an operation at the reproduction, editing or retrieval, and
the recording processor records the support data onto the recording medium in accordance with the matching result information and the operation attribute information.

6. The information processing apparatus according to claim 5, wherein
the operation attribute information regulates a recording position determination method to determine a position where a marker is recorded, in the use object data and with reference to a position of a starting or terminal end of a period detected in the matching result, and
the recording processor determines the position in the use object data in accordance with the matching result information and the operation attribute information, and records the marker as the support data at the determined position.

7. The information processing apparatus according to claim 5, wherein
the operation attribute information regulates a recording position determination method to determine a position where the use object data is divided, in the use object data and with reference to a position of a starting or terminal end of a period detected in the matching result, and
the recording processor determines the position in the use object data in accordance with the matching result information and the operation attribute information, and divides the use object data at the determined position.

8. The information processing apparatus according to claim 6 or 7, wherein
the operation attribute information regulates a creation method of text information relevant to the matching result, and
the recording processor creates the text information relevant to the matching result in accordance with the regulated creation method of the text information, associates it with the recorded marker or the divided portion, and records the created text information as the support data.

9. The information processing apparatus according to claim 8, wherein
the key data includes text information relevant to the key data, and
the m recording processor creates the text information relevant to the matching result in accordance with the regulated creation method of the text information and based on the text information relevant to the key data.

10. The information processing apparatus according to any one of claims 1 to 5, wherein
the key data includes text information relevant to the key data, and
the recording processor creates text information relevant to the matching result in accordance with a previously regulated creation method of text information and based on the text information relevant to the key data, and records the text information relevant to the matching result as the support data.

11. The information processing apparatus according to claim 9 or 10, wherein the text information relevant to the matching result includes the text information relevant to the key data and time information of the matching result.

12. The information processing apparatus according to any one of claims 9 to 11, further comprising:
a key audio data acquisition processor to acquire audio data as the retrieval key;
a key specification information input unit to input key specification information for specifying a whole or partial period of the acquired key audio data;
a key creation processor to create audio pattern data by cutting out the whole or partial period of the key audio data based on the inputted key specification information; and
a key data acquisition processor to acquire the text information relevant to the key data based on the inputted key specification information,
wherein the key data includes the text information relevant to the key data acquired in the key data acquisition processor.

13. The information processing apparatus according to any one of claims 1 to 12, wherein
the key data includes title information relevant to the key data, and
the recording processor records, as the support data, the title information relevant to a whole series of use object data included in the matching result.

14. The information processing apparatus according to claim 13, further comprising:
a key audio data acquisition processor to read and acquire audio data as the retrieval key;
a key specification information input unit to input key specification information for specifying a whole or partial period of the acquired key audio data;
a key creation processor to create audio pattern data by cutting out the whole or partial period of the key audio data based on the inputted key specification information; and
a key data acquisition processor to acquire title information relevant to the key data based on the inputted key specification information,
wherein the key data includes the title information relevant to the key data acquired in the key data acquisition processor.

15. The information processing apparatus according to any one of claims 1 to 14, wherein
the key data includes information relating to a storage method of a title relevant to the key data, and
the recording processor records a whole series of use object data included in the matching result in accordance with the information relating to the storage method of the title included in the key data.

16. The information processing apparatus according to any one of claims 1 to 15, wherein
the key data includes matching method information to specify a matching method in the key matching, and
the key matching processor performs the matching in accordance with the specified matching method information.

17. The information processing apparatus according to any one of claims 1 to 16, wherein
the key data includes matching parameter information to specify a parameter at a matching time in the key matching, and
the key matching processor performs the matching in accordance with the specified matching parameter information.

18. The information processing apparatus according to any one of claims 1 to 17, wherein the support data is metadata.

19. An information processing method for creating support data to support a user to enable reproduction, editing or retrieval in an operation desired by the user when the user reproduces, edits or retrieves use object data including video/audio data or only audio data, comprising:
acquiring only audio data as use object audio data from the use object data;
recording key data including audio pattern data as a retrieval key for the reproduction, the editing or the retrieval;
checking the use object audio data against the audio pattern data based on a specified condition, and obtaining matching result information indicating a position satisfying the specified condition in the use object audio data; and
recording the matching result information as the support data onto a recording medium.

20. A program product for causing a computer to realize an information processing method for creating support data to support a user to enable reproduction, editing or retrieval in an operation desired by the user when the user reproduces, edits or retrieves use object data including video/audio data or only audio data, the program product comprising instructions of:
acquiring only audio data as use object audio data from the use object data;
recording key data including audio pattern data as a retrieval key for the reproduction, the editing or the retrieval;
checking the use object audio data against the audio pattern data based on a specified condition, and obtaining matching result information indicating a position satisfying the specified condition in the use object audio data; and
recording the matching result information as the support data onto a recording medium.
